(19) United States
(12) Patent Application Publication
(10) Pub. No.: US 2021/0333913 A1
(43) Pub. Date: Oct. 28, 2021

(54) TOUCH CONTROL DISPLAY PANEL AND DISPLAY DEVICE

(71) Applicant: HUIZHOU CHINA STAR OPTOELECTRONICS TECHNOLOGY CO., LTD., Huizhou (CN)

(72) Inventors: Chingyuan CHEN, Huizhou (CN); Quan LI, Huizhou (CN); Guofu TANG, Huizhou (CN); Yuchun HSIAO, Huizhou (CN)

(73) Assignee: HUIZHOU CHINA STAR OPTOELECTRONICS TECHNOLOGY CO., LTD., Huizhou (CN)

(21) Appl. No.: 16/619,096

(22) PCT Filed: Nov. 4, 2019
(86) PCT No.: PCT/CN2019/115363

§ 371 Date: Dec. 4, 2019

(30) Foreign Application Priority Data
May 27, 2019 (CN) 201910444466.3

(51) Int. Cl. G06F 3/041; G06F 3/044; G02F 1/1333

(52) U.S. Cl. CPC G06F 3/0412; G06F 3/044; G02F 1/133331; G02F 1/133305; G02F 1/13338

(57) ABSTRACT

A touch control display panel includes a display module and a touch control conductive film, and the display module and the touch control conductive film are sequentially disposed, and a surface of the display module includes an active region and an inactive region, and the display module includes a substrate, a circuit layer, and a display functional layer which are sequentially disposed, and a sum of an area of the active region and an area of the inactive region is equal to an area of the touch control conductive film.

### BACKGROUND OF INVENTION

### Field of Invention

The present invention relates to a field of display panel, and more particularly to a touch control display panel and a display device.

### Description of Prior Art

Generally, a touch control display panel includes a touch control conductive film and a liquid crystal display module. In a current touch control display panel, the touch control conductive film has a circuit layer for transmitting the touch signal, and the circuit layer is usually disposed on a side of the touch control conductive film facing the liquid crystal display module.

Referring to FIG. 1, the touch display panel includes a liquid crystal display module 1, a touch control conductive film 2, and a glass cover 3. The liquid crystal display module 1, the touch control conductive film 2, and the glass cover 3 are sequentially disposed. The overall area of the touch control conductive film 2 is larger than the area of liquid crystal display module 1 due to a peripheral wire of the touch control conductive film 2. In addition, the touch control conductive film 2 is a flexible substrate, and when the touch control conductive film 2 is attached and bonded to the liquid crystal display module 1, there are problems such as air bubbles at the edge of the crystal display module 1, which results in operational difficulty. Thus, the touch control conductive film 2 can only be attached and bonded to the glass cover. Furthermore, the frame area of the liquid crystal display panel is too small, so it cannot be bonded to the touch module. For the above reasons, current capacitive touch control screens are all provided with a glass cover, so that weight and cost cannot be reduced.

### SUMMARY OF INVENTION

A touch control display panel is provided to solve the problems like that when the touch control conductive film is attached and bonded to the liquid crystal display module, there are air bubbles at the edge of the crystal display module, which results in operation difficulty.

A touch control display panel includes a display module and a touch control conductive film, and the display module and the touch control conductive film are sequentially disposed, and a surface of the display module includes an active region and an inactive region, and the display module includes a substrate, a circuit layer, and a display functional layer which are sequentially disposed, and a sum of an area of the active region and an area of the inactive region is equal to an area of the touch control conductive film.

In one embodiment, the circuit layer is only disposed in the active region.

In one embodiment, the functional layer includes a liquid crystal display functional layer.

In one embodiment, the functional layer includes an organic light emitting diode (OLED) functional layer.

In one embodiment, the inactive region can be cut.

In one embodiment, the circuit layer is disposed on the substrate, the display functional layer is disposed on the circuit layer, and the touch control conductive film is disposed on the display functional layer.

In one embodiment, touch control display panel further includes a glass cover disposed above the touch control conductive film.

In one embodiment, an area of the glass cover is equal to an area of the touch control conductive film.

In one embodiment, an area of the glass cover is greater than an area of the touch control conductive film.

A touch control display device is further provided to include a main body and the touch control display panel according to the embodiments, and the touch control display panel is disposed on the main body.

The touch control display panel according to one embodiment of the present invention increases the area of the inactive region around the display module based on the size of the touch control conductive film, and the area of the inactive region around the display module is identical to the touch control conductive film. Therefore, the attaching and bonding yield of the touch control conductive film and the display module are increased, and the touch control conductive film and the glass cover are not required to be attached together, thereby achieving the purpose of reducing weight and cost.

### BRIEF DESCRIPTION OF DRAWINGS

In order to more clearly illustrate embodiments or technical solutions in the present invention, the drawings used in the description of the embodiments or current technology will be briefly described below. Obviously, the drawings in the following description are merely some embodiments of the present invention. A person skilled in the art may also obtain other drawings without any creative efforts.

FIG. 1 is a schematic view of a touch control display panel in the prior art.

FIG. 2 is a schematic view of a touch display panel according to first embodiment of the present invention.

FIG. 3 is a schematic cross-sectional view of the display module according first embodiment of the present invention.

FIG. 4 is a schematic top plan view of the display module according to first embodiment of the present invention.

FIG. 5 is a schematic view of a touch control display panel according to second embodiment of the present invention.

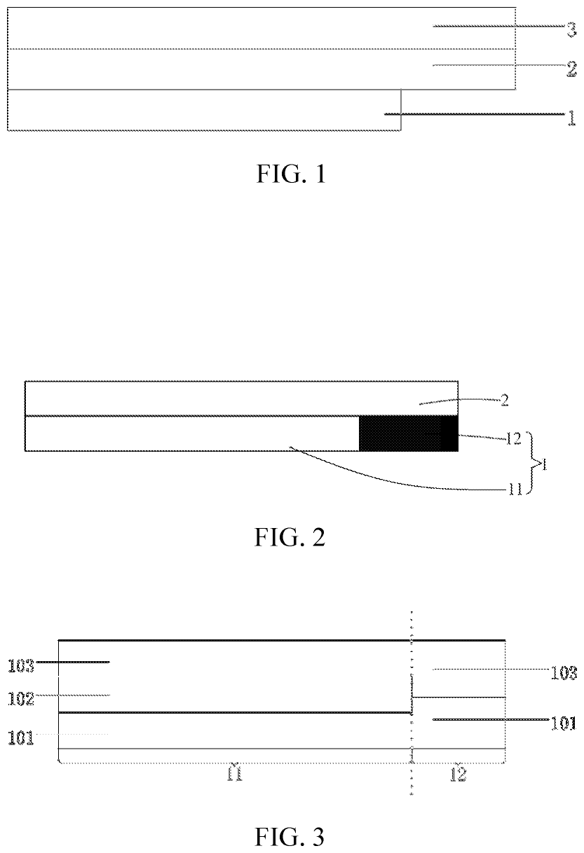

### DETAILED DESCRIPTION OF PREFERRED EMBODIMENTS

The technical solutions in the embodiments of the present invention are clearly and completely described in the following with reference to the accompanying drawings in the embodiments of the present invention. It is obvious that the described embodiments are only a part of the embodiments of the present invention, but not all embodiments. All other embodiments obtained by those skilled persons without creative efforts in the art based on the embodiments of the present invention are within the scope of the present invention.

The specific structure and function disclosed are merely representative and are for the purpose of describing exemplary embodiments of the invention. The present invention may, however, be embodied in many alternative forms and should not be construed as being limited only to the embodiments set forth herein.

In first embodiment, the touch control conductive film has a circuit layer for transmitting the touch signal in current touch control display panels, and the circuit layer is usually disposed on a side of the touch control conductive film facing the liquid crystal display module.

The overall area of the touch control conductive film is larger than the area of liquid crystal display module due to peripheral wire of the touch control conductive film. In addition, the touch control conductive film is a flexible substrate, and when the touch control conductive film is attached and bonded to the liquid crystal display module, there are problems such as air bubbles at the edge of the crystal display module, which results in operation difficulty. Thus, the touch control conductive film can only be attached and bonded to the glass cover. Furthermore, the frame area of the liquid crystal display panel is too small, so it cannot be bonded to the touch module. For the above reasons, current capacitive touch control screens are all provided with a glass cover, so that the weight and cost cannot be reduced.

In one embodiment, a touch control display panel is provided. Referring to FIG. 2, it is a schematic view of a touch display panel according to first embodiment of the present invention. The touch control display panel includes a liquid crystal display module 1 and a touch control conductive film 2 disposed on the liquid crystal display module 1.

The liquid display module 1 includes an active region 11 and an inactive region 12, and a secondary cutting can be performed on the inactive region 12.

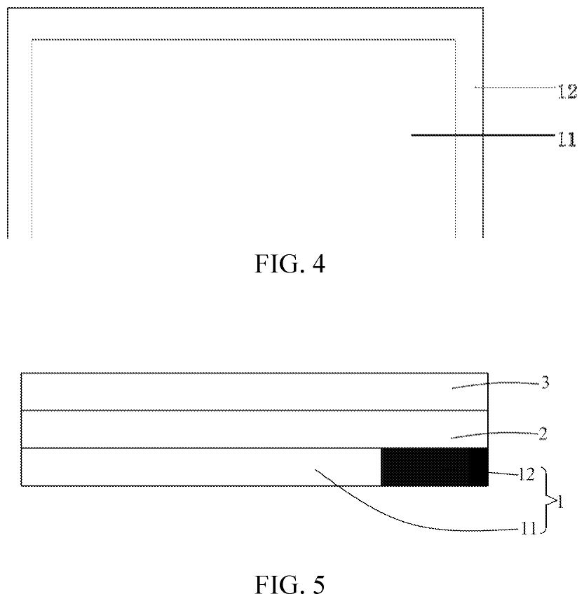

FIG. 3 and FIG. 4 are cross-sectional view and top plan view of a display module according one embodiment of the present invention. The liquid crystal display module 1 includes a substrate 101, a circuit layer 102 disposed on the substrate 101, and a display functional layer 103 disposed on the circuit layer 102.

The circuit layer 102 is only disposed in the active region 11, and a secondary cutting can be performed on the inactive region 12. There is no circuit layer in the inactive region 12, otherwise it will cause abnormalities when the inactive region 12 is cut.

The substrate 1 is a polyimide (PI) film, which is used as a substrate of the liquid crystal display module 1. The polyimide film is a film-type insulating material with better performance in the world, and has strong tensile strength. It is obtained by polycondensation and casting of pyromellitic dianhydride and diaminodiphenyl ether in a strong polar solvent to form a film and then the film is aminated.

In the embodiment, the display functional layer is a liquid crystal display functional layer. In other embodiments, the display functional layer may also be an organic light emitting diode display functional layer, which may be adopted as needed, and is not limited herein.

A sum of an area of the active region 11 and an area of the inactive region 12 is equal to an area of the touch control conductive film 2. Therefore, it can avoid that the peripheral wire of the touch control conductive film is floated in the prior art.

The attaching and bonding yield of the touch control conductive film and the display module are increased, and the touch control conductive film and the glass cover are not required to be attached together, thereby achieving the purpose of reducing weight and cost.

In second embodiment, referring to FIG. 5, it is a schematic view of a touch control display panel according to one embodiment of the present invention. The display module includes an active region and an inactive region, which are substantially the same as the corresponding touch control display panel in the first embodiment. For the same elements, it can be referred to the corresponding description in the first embodiment, and details are not described herein again. The main difference between the first embodiment and the second embodiment is that a glass cover 3 is disposed on the touch control conductive film 2 of the touch control display panel, and an area of the glass cover 3 is equal to an area of the touch control conductive film 2.

In other embodiments, an area of the glass cover is greater than an area of the touch control conductive film, and it is not limited herein.

The touch control display panel according to one embodiment of the present invention increases the area of the inactive region around the display module based on the size of the touch control conductive film, and the area of the inactive region around the display module is identical to the touch control conductive film. Therefore, the attaching and bonding yield of the touch control conductive film and the display module are increased.

In third embodiment, a touch control display device includes a main body, and the touch control display panel of the first embodiment is disposed on main body.

The touch control display panel according to one embodiment of the present invention increases the area of the inactive region around the display module based on the size of the touch control conductive film, and the area of the inactive region around the display module is identical to the touch control conductive film. Therefore, the attaching and bonding yield of the touch control conductive film and the display module are increased, and the touch control conductive film and the glass cover are not required to be attached together, thereby achieving the purpose of reducing weight and cost.

In the above, the present application has been described in the above preferred embodiments, but the preferred embodiments are not intended to limit the scope of the invention, and a person skilled in the art may make various modifications without departing from the spirit and scope of the application. The scope of the present application is determined by claims.

What is claimed is:

1. A touch control display panel, comprising a display module and a touch control conductive film, wherein the display module and the touch control conductive film are sequentially disposed, and a surface of the display module comprises an active region and an inactive region, and the display module comprises a substrate, a circuit layer, and a display functional layer which are sequentially disposed, and a sum of an area of the active region and an area of the inactive region is equal to an area of the touch control conductive film.

2. The touch control display panel according to claim 1, wherein the circuit layer is only disposed in the active region.

3. The touch control display panel according to claim 1, wherein the functional layer comprises a liquid crystal display functional layer.

4. The touch control display panel according to claim 1, wherein the functional layer comprises an organic light emitting diode (OLED) functional layer.

5. The touch control display panel according to claim 1, wherein the inactive region can be cut.

6. The touch control display panel according to claim 1, wherein the circuit layer is disposed on the substrate, the display functional layer is disposed on the circuit layer, and the touch control conductive film is disposed on the display functional layer.

7. The touch control display panel according to claim 1, further comprising a glass cover disposed above the touch control conductive film.

8. The touch control display panel according to claim 7, wherein an area of the glass cover is equal to an area of the touch control conductive film.

9. The touch control display panel according to claim 7, wherein an area of the glass cover is greater than an area of the touch control conductive film.

10. A touch control display device, comprising a main body and the touch control display panel of claim 1, wherein the touch control display panel is disposed on the main body.

11. The touch control display device according to claim 10, wherein the circuit layer is only disposed in the active region.

12. The touch control display device according to claim 10, wherein the functional layer comprises a liquid crystal display functional layer.

13. The touch control display device according to claim 10, wherein the functional layer comprises an organic light emitting diode (OLED) functional layer.

14. The touch control display device according to claim 10, wherein the inactive region can be cut.

15. The touch control display device according to claim 10, wherein the circuit layer is disposed on the substrate, the display functional layer is disposed on the circuit layer, and the touch control conductive film is disposed on the display functional layer.

16. The touch control display device according to claim 10, further comprising a glass cover disposed above the touch control conductive film.

17. The touch control display device according to claim 16, wherein an area of the glass cover is equal to an area of the touch control conductive film.

18. The touch control display device according to claim 16, wherein an area of the glass cover is greater than an area of the touch control conductive film.
